(19) United States
(12) Patent Application Publication
(10) Pub. No.: US 2006/0224432 A1
(43) Pub. Date: Oct. 5, 2006

(54) Workflow scheduling system

(75) Inventor: Yang Li, Suffolk (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS public limited company, London (GB)

(21) Appl. No.: 11/374,051

(22) Filed: Mar. 14, 2006

(30) Foreign Application Priority Data
Mar. 31, 2005 (EP) 05252032.7

(51) Int. Cl. G06F 9/46

(52) U.S. Cl. 705/9

(57) ABSTRACT

A workflow scheduling system arranged to provide a workflow to a user who has requested work to be implemented comprises means to generate a workflow comprising an a set of actions and a logical dependency between the actions; means to allocate a resource capacity to each action; and means to assign of one or more of said resources forming the resource capacity to a task comprising one or more of said actions. The system is arranged to enable a user to add one or more constraints dynamically to the workflow scheduling system without the need for the workflow scheduler to be recompiled to apply a constraint to the resources allocated to one or more tasks.

The present invention relates to a workflow scheduling system and related aspects.

In particular, but not exclusively, the invention relates to a workflow scheduler which can be remotely configured by a user using a web-portal type of user interface. In particular, but not exclusively, the user interface enables a user to provide one or more time-constraints for a workflow schedule prior to the workflow schedule being generated by the scheduling system. The time-constraints constrain how a workflow scheduler of the system seeks to optimise the utilisation of the collective (and optionally also the individual) resources required to implement the workflow.

Workflow schedulers which optimise the use of enterprise resources when responding to a demand for the services which utilise those resources are well known to those skilled in the art. In automated workflow scheduling systems, each request for work received by the scheduler is automatedly responded to by generating a workflow. The provision of a workflow involves generating an abstract workflow, workflow scheduling and task generation. An abstract workflow is a set of actions and the logic dependency among these actions. Workflow scheduling involves allocating resource capacity (such as the number of engineers) to each action in the workflow. Task generation involves assignment of one or more specific, e.g. concrete resources (such as a particular engineer) to each task.

In large organisations, a demand exists to provide a customers with a particularly well-connected service so that customer requests can be transformed into scheduled operational tasks as fast as possible. It is possible to address this by providing a workflow schedule fine-tuning mechanism that allows customers to self-service themselves, such as is described in United Kingdom Patent Application GB-A-0427133, entitled “WORKFLOW SCHEDULER”.

Web-based portals enabling an end-user, e.g., a customer, to place a service order online and give their own timing constraint are also known in the art. However, such web-based portals generally do not dynamically interface with the workflow systems provided on the back-end of the system. Such back-end systems are arranged to either directly perform resource allocation or are arranged to interface with one or more other resource allocation systems. Known schedulers instead will try to ensure that the workflows which are generated optimise the utilisation of the resources, and select a workflow off-line which complies with the preferences the end-user has indicated via the web-based portal.

The workflow schedule fine-tuner described in GB-A-0427133 uses the inputted information to generate a scheduled workflow based on the availability of a backend resource. The workflow schedule fine-tuner can also generate appointments and present them to the customer. The customer can fine-tune the appointments online until he/she is satisfied with the appointments. The scheduler will seek to work out one workflow schedule that satisfies the timing constraint given the user. The workflow schedule is the fastest schedule that can be obtained given the timing constraint.

Automated schedulers known in the art do not offer the end-user means to control the scheduling by providing more complex scheduling preferences. This means that appointments are still optimised solely for the relevant resource organisation(s).

The scheduler described in GB-A-0427133 is limited in that the only consideration for the end-user's convenience is that the user can select individual appointments for fine-tuning. The end-user has little control over the entire job, i.e., they are not able to set global constraints for all appointments so that the entire job is completed in as short as an amount of time as possible.

For example, if the provision of a new service involves the installation of new equipment at the end-user, for example, a customer's premises, the customer may prefer to have the engineering work finished as quick as possible to minimise the disturbance to the office or their home. In such a case, the customer may wish the system to work out a workflow schedule that has a total time span as short as possible, even if it would be possible to complete the installation sooner if the appointments were scattered over a three day period instead of all being performed in just one day. It is particularly advantageous for residential customers if appointments are all generated for the same day even if this means a slightly longer wait.

Accordingly, known workflow schedulers are limited as they seek to optimise the utilisation of resources from each resource provider without taking into account that the optimisation schemes used optimise exclusively for the resource provider. If a user is only able to select from pre-optimised schedules, the user is not able to have their specific constraints included in the optimisation process, which means that the user may not receive a workflow schedule fully suited to their individual requirements.

Whilst it is possible to manually configure and schedule a workflow by interacting with the customer, as organisations have become more complex, manual workflow scheduling has become less and less satisfactory. It is simply no longer possible to manually explore the large number of possible workflows to assess their individual feasibility and suitability for the user and for the enterprise providing the relevant resources (including manpower). Moreover in such systems, the user was not able to directly control the schedules generated, as they were not provided with any direct control interface. The complexity of the task for many large organisations would occupy an unrealistic amount of time for both the user and the person(s) trying to co-ordinate all the relevant parts of the system to generate the workflow. Each time a customer sought to change a part of the workflow generated, the entire process would need to be restarted. For large organisations, with large customer bases, the process is economically impossible unless automated systems are provided to ensure that resources are utilised efficiently. Thus the workflow scheduling system according to the invention amounts to more than a computer program per se, in that one or more technical effects are provided.

The present invention seeks to provide a workflow scheduling system which mitigates and/or obviates some of the limitations and problems associated with known workflow schedulers by providing an interface that allows the customer to request work and to select one or more constraints (equivalent to specifying one or more user preferences) for how the work requested is to be implemented. The constraints are time-related and can be associated with the entire workflow or individual appointments. The constraints determine when (and optionally how) the work is implemented and are provided by the user via the customer front-end portal to the back-end workflow scheduler of the workflow scheduling system both prior to the generation of a workflow schedule to implement the work requested (by means of initial constraints which may be global (i.e., relating to all appointments collectively) or local (relating to one or more appointments), and/or after an initial workflow schedule has been generated.

The workflow scheduling system seeks to enable an end-user to globally and locally constrain the range and duration of a plurality of appointments which are to be scheduled by a work manager. The term global constraint is used herein in the sense that all of a plurality of appointments must satisfy the constraint; the term local constraint is used herein in the sense that each appointment must satisfy a specific local constraint applied to it. A local constraint may be shared by one or more appointments, however, if all appointments must satisfy a constraint, the constraint is a global constraint. Examples of global constraints include, for example, finding a scheduled workflow with shortest time span or having as few appointments as possible. An example of a local constraint would be for the first appointment required to be scheduled after 8 am in the morning (this could also be a global constraint if applied to all appointments).

### SUMMARY STATEMENTS OF INVENTION

A first aspect of the invention seeks to provide a workflow scheduling system arranged to provide a workflow to a user who has requested work to be implemented, the system comprising: means to generate a workflow comprising a set of actions and a logical dependency between the actions; means to allocate a resource capacity to each action; means to assign of one or more of said resources forming the resource capacity to a task comprising one or more of said actions, wherein the system is arranged to enable a user to add one or more constraints dynamically to the workflow scheduling system without the need for the workflow scheduler to be recompiled to apply a constraint to the resources allocated to one or more tasks.

The means to allocate a resource capacity to each action may allocate resource capacity based on the type of task an action forms and the time-slots available to implement that type of task, wherein each time-slot is representative of the total resource capable of performing the task.

The total resource each time-slot may be representative of comprises the total number of individuals capable of performing a type of task.

The means to allocate a resource capacity to each action may comprise means to allocate resource capacity in dependence on the availability of each individual resource required.

An individual resource may comprise a type of task. An individual resource may comprise an individual (i.e., a person or engineer). An individual resource may comprise each individual's available time-slots.

The system may further comprises: means to allocate one or more appointments for the required resources to implement all tasks required to fulfil the request for work, wherein the means to allocate an appointment is arranged to maximise the number of tasks allocated to each appointment.

The above means may comprise an appointments generator arranged to merge a plurality of logically related tasks into single appointments, which can then be scheduled by the workflow system.

The user may be capable of selecting one or more of a plurality of appointments offered by the system. If the user selects an inconsistent appointment for a particular task or set of tasks in the workflow, an indication of the inconsistency may be provided to the user.

A second aspect of the invention seeks to provide a method of scheduling a workflow generated in response to a user generating a request for work, the workflow comprising a plurality of tasks each of which must be implemented to fulfil the request for work, the method comprising: receiving a user initiated request for work; receiving input from the user comprising one or more initial constraints on a schedule for fulfilling the request for work; generating a workflow to fulfil said request for work; processing said one or more initial constraints inputted by the user; generating one or more proposed schedules for the workflow, the schedules complying with said one or more global constraints; communicating information relating to said one or more proposed schedules to the user; receiving one or more additional constraints from the user for a schedule to implement the proposed workflow; processing said additional constraints inputted by the user to generate one or more revised schedules for the proposed workflow which comply with said one or more additional constraints; selecting one of said revised proposed workflows according to a set of one or more optimisation rules; and communicating said selected revised proposed workflow to the user.

The user may be able to add one or more additional constraints dynamically without the need for the workflow scheduler to be recompiled.

The steps in the method may be arranged to enable a user to iterate the additional constraint selection step and subsequent steps to further constrain the revised proposed workflows. The steps in the method may be arranged to enable a user to fine-tune the selected revised proposed workflows.

An initial constraint may comprise a global constraint. An additional constraint may comprise a global constraint. An additional constraint may comprise a local constraint. A global constraint may comprise a start time and/or an end time and/or a duration for the entire workflow. A local constraint may comprise a start time and/or an end time and/or a duration for one or more tasks forming a subset of the tasks forming the entire workflow.

The additional constraint may constrain the number of appointments required to implement the work to a predetermined number. The additional constraint may constrain the number of appointments required to implement the work to a the least number required.

The optimisation rules may seek to optimise the utilisation of the collective capacity a resource required to implement the work requested. The method may further comprise the step of seeking to optimise the utilisation of each individual resource required prior to said step of communicating the workflow to the end-user.

The further step seeking to optimise the utilisation of each individual resource may comprise communicating the revised workflow to a work manager arranged to optimise the utilisation of each individual resource, and wherein said work manager performs said step of further optimising the workflow, and said work manager communicates said further optimised workflow to the workflow scheduling system for communication to the end-user.

A third aspect of the invention seeks to provide a workflow scheduling system arranged to schedule a workflow generated in response to a user generating a request for work, the workflow comprising a plurality of tasks each of which must be implemented to fulfil the request for work, the apparatus comprising: means to receive a user initiated request for work; means to receive input from the user comprising one or more initial constraints on a schedule for fulfilling the request for work; means to generate a workflow to fulfil said request for work; means to process said one or more initial constraints inputted by the user; means to generate one or more proposed schedules for the workflow, the schedules complying with said one or more global constraints; means to communicate information relating to said one or more proposed schedules to the user; means to receive one or more additional constraints from the user for a schedule to implement the proposed workflow; means to process said additional constraints inputted by the user to generate one or more revised schedules for the proposed workflow which comply with said one or more additional constraints; means to select one of said revised proposed workflows according to a set of one or more optimisation rules; and means to communicate said selected revised proposed workflow to the user.

A fourth aspect of the invention seeks to provide a user interface arranged to enable a user to provide input to the system according to any system aspect, the user interface comprising: means for a user to initiate a request for work to be scheduled by the system; means to provide input from the user to the system comprising one or more initial constraints on the schedule the system is to generate for fulfilling the request for work; means to provide one or more additional constraints from the user to the system for the schedule to implement the proposed workflow; and means to receive information indicated the workflow finally proposed by the system to fulfil the requested work.

A fifth aspect of the invention seeks to provide a scheduling system for use in a workflow scheduling system according to any system aspect, the scheduler comprising: means to generate one or more proposed schedules for a workflow, the schedules complying with said one or more global constraints; means to communicate information relating to said one or more proposed schedules to the system for communication to the user; means to receive one or more additional constraints from the user for a schedule to implement the proposed workflow; means to process said additional constraints inputted by the user to generate one or more revised schedules for the proposed workflow which comply with said one or more additional constraints; means to select one of said revised proposed workflows according to a set of one or more optimisation rules; and means to communicate said selected revised proposed workflow to the user via said system.

A sixth aspect of the invention seeks to provide an appointments generator arranged for use in any appropriate system aspect, wherein the appointments generator is provided as part of an appointment reservation system implemented in a distributed computing environment arranged to permit multiple access to the system, and in which each user is allocated a single session, each session storing information on the user's appointment preferences.

Another aspect of the invention seeks to provide a computer program comprising instructions for causing one or more processing means to performing any method aspect when the instructions are executed by one or more processing means.

Another aspect of the invention seeks to provide a suite of one or more computer programs providing any appropriate workflow scheduling system aspect.

The aspects and preferred embodiments of the invention are as set out above and in the accompanying independent and dependent claims respectively. Those skilled in the art will appreciate that the aspects and preferred embodiments of the invention may be suitably combined in any appropriate manner where suitable combinations are apparent to those skilled in the art.

The preferred embodiments of the invention will now be described with reference to the accompanying drawings which are by way of example only and in which:

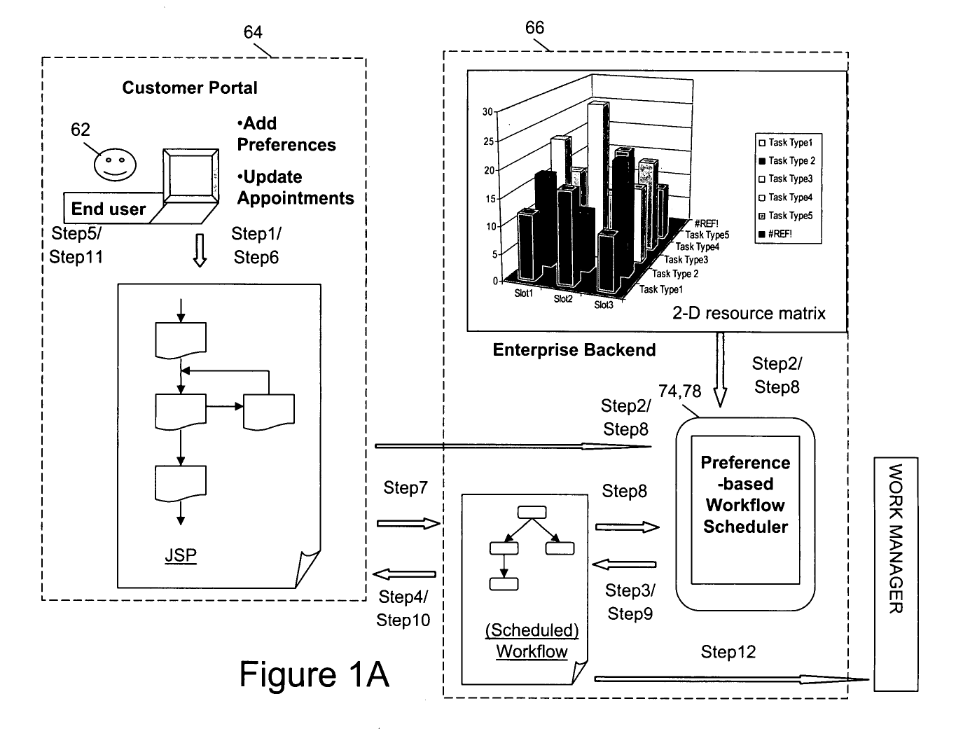

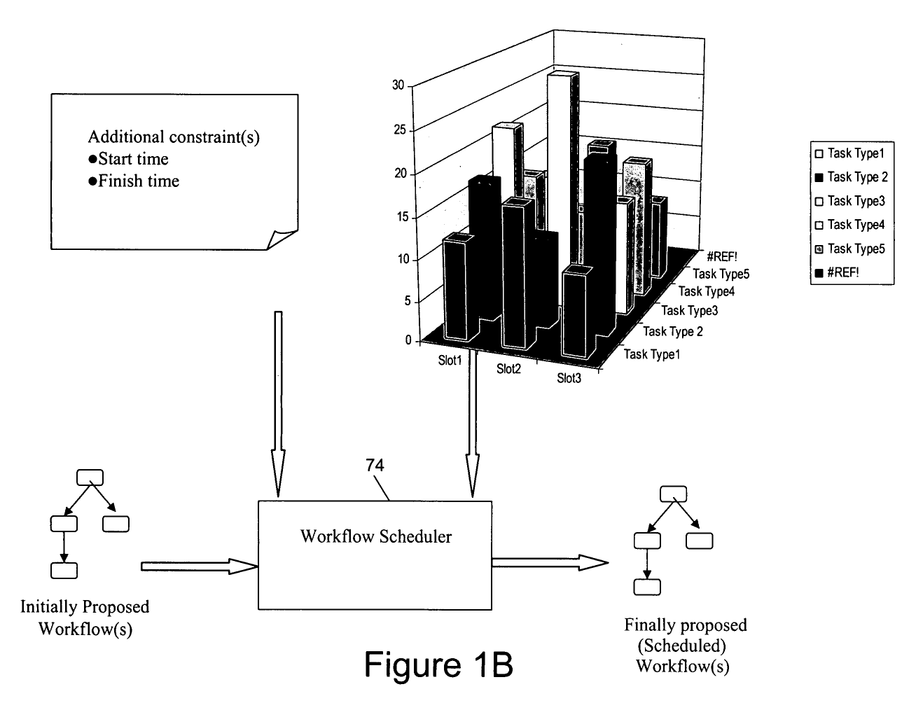

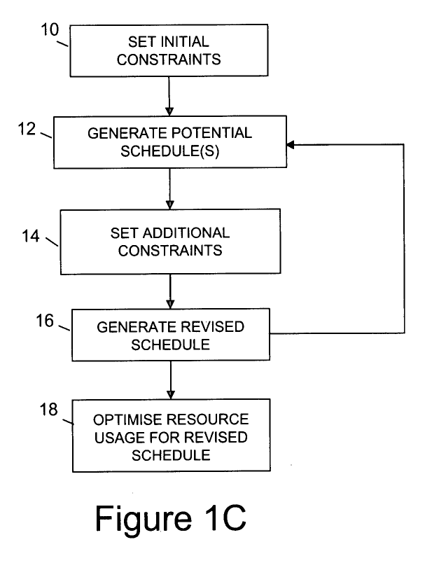

FIG. 1A shows schematically a workflow scheduling and appointment generation system according to the invention;

FIG. 1B shows in more detail the processes performed by the workflow scheduler shown in FIG. 1A;

FIG. 1C shows steps the provision of a workflow according to one embodiment of the invention;

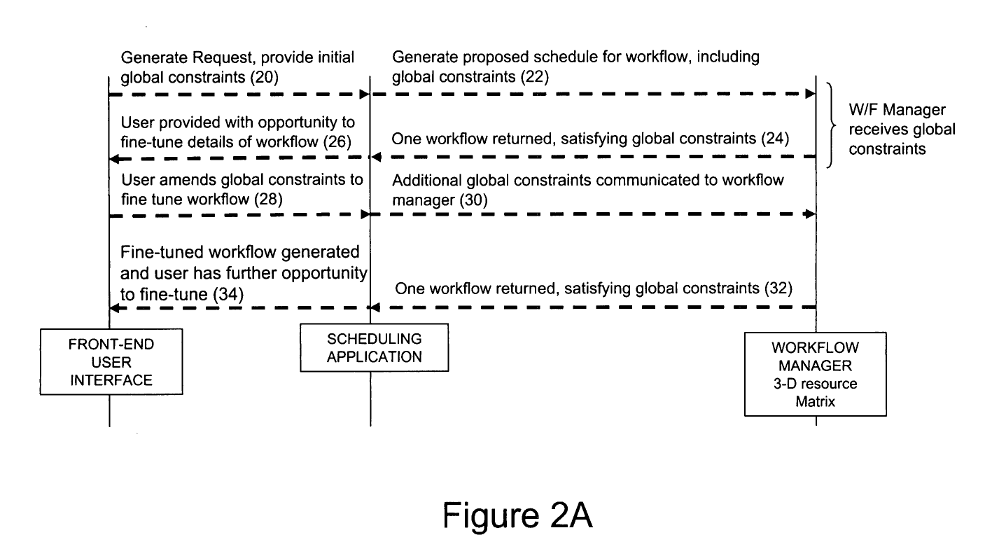

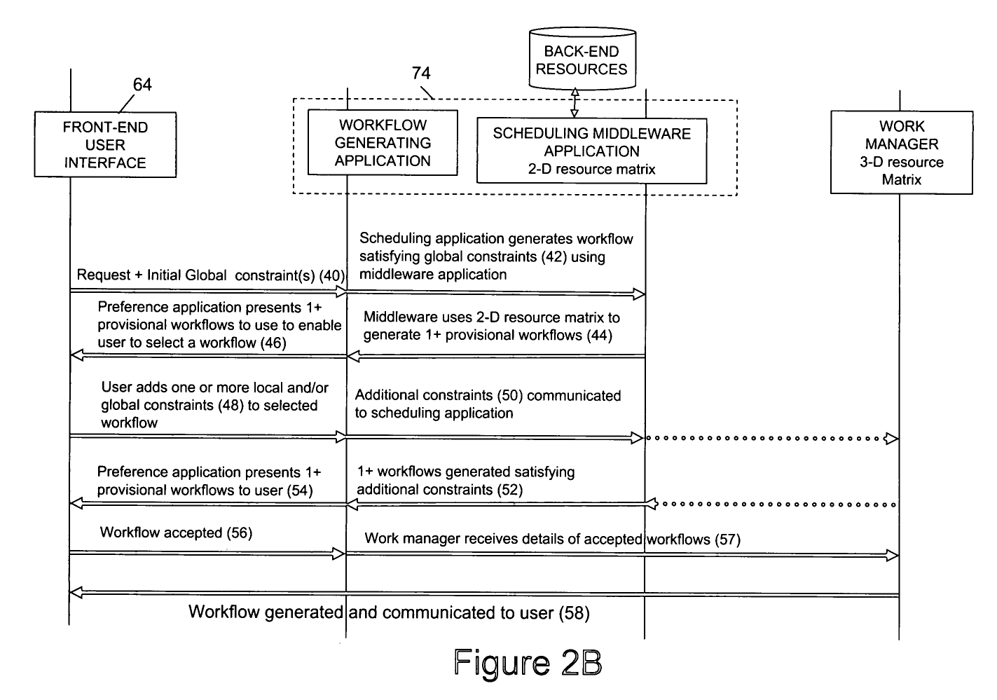

FIG. 2A shows steps in a workflow scheduling system in which a user is presented with an opportunity to fine-tune a workflow;

FIG. 2B shows steps in a workflow scheduling system according to the invention;

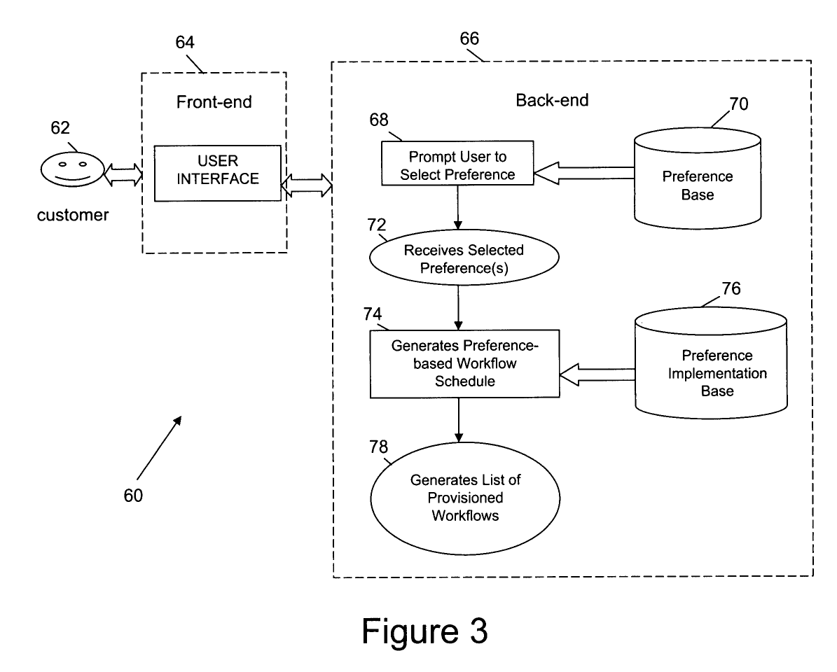

FIG. 3 shows elements of the workflow generation process performed by the back-end of the system shown in FIG. 1A in more detail;

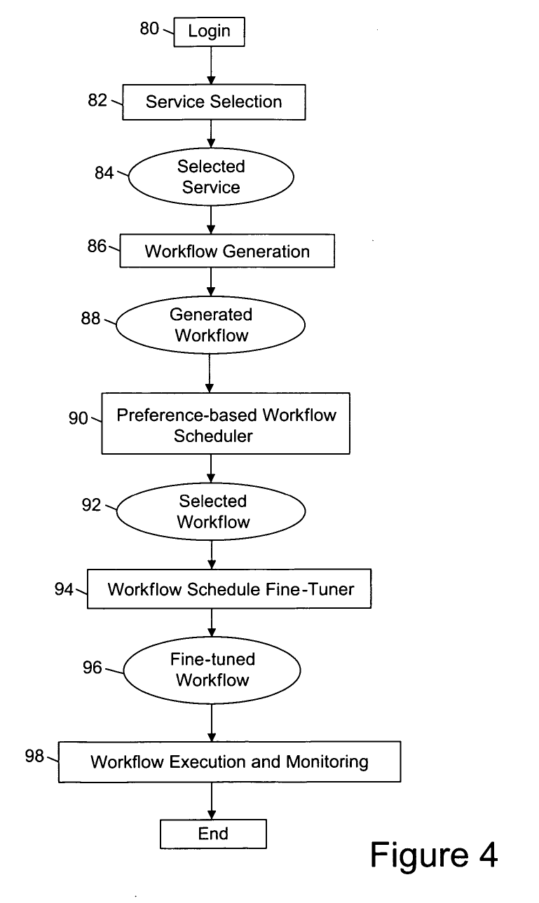

FIG. 4 shows the flow chart of preference-based workflow scheduler according to an embodiment of the invention; and

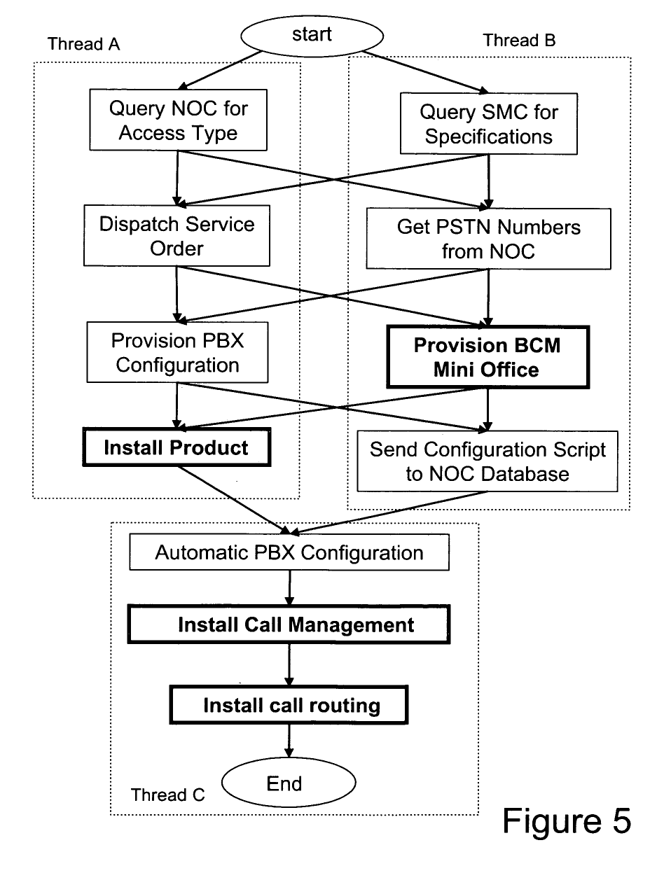

FIG. 5 shows the tasks in a general workflow schedule generated according to an embodiment of the invention; and

The best mode of the invention as currently contemplated by the inventors will now be described with reference to the accompanying drawings. Those skilled in the art will appreciate that the embodiments described hereinbelow are simplified for clarity and that the description is intended to include references to equivalent features and those features whose inclusion in the description is implicit or implied where such references would be apparent to those skilled in the art.

FIG. 1A shows a customer portal 64 in which an end user 62, for example a customer, of a workflow scheduling system 60 according to the invention is able to request a service and exert a level of control over the way in which the requested service is generated by back end 66 using a front end interface to the back-end, shown in FIG. 1A as customer portal 64. The term “customer” is used herein in the sense of an end-user requesting work, where the term “work” is used to refer to anything requiring a series of appointments to be scheduled. Thus the term “customer” could also apply to an end-user seeking to schedule a series of appointments for medical treatment or for any other type of service requiring a series of appointments, and does not imply that a commercial transaction is required.

In FIG. 1A, the front end is represented using a web-application, for example, Java applet pages (JSP) which are hosted by an appropriate platform and provided over a communications network to the end user. The user 62 is able to request some work, for example from a service provider to provide a service such as, for example, the installation of a particular product and is able to set some initial constraints for when the requested work is to be implemented using the front-end customer portal 64. Customer portal 64 thus provides an interface to the back-end of the scheduling system, which provides means to generate a workflow and to schedule the workflow subject to constraints provided by the user 62 via the interface 64. Examples of initial constraints include the final completion time and/or earliest start time for the requested work.

The request and the initial constraints for implementing the requested work are communicated by the front end portal 64 over a communications network to a back-end system 66. The back-end system comprises an preference-based workflow scheduler 74 which includes means to generate one or more workflows conforming to the global constraints comprising an interface 78 and a resource database 76. The interface 78 comprises an application which functions as middleware between the preference-based workflow scheduler 74 and a work manager which has full awareness of all of the resources required to implement the requested work.

The interface 78 has access to a limited number of resources, as is represented by the two-dimensional resource matrix shown in FIG. 1A and in more detail in FIG. 1B.

In FIG. 1A, at step 1, the user can set up preferences on workflow scheduling and provide initial overall timing constraints. These inputs are passed via front-end GUI (such as Java Servlet Pages or JSP) at step 2 to the Preference-based Workflow Scheduler. The workflow scheduler will also look up at the 2-D resource matrix, at this step, to allocate resource capacity to the workflow. The output from step 2 is one or more scheduled workflows that satisfy the constraints given by the user or inherited in the workflow. The scheduled workflow is recorded as a Scheduled Workflow at step 3, and is further transformed into JSP at step 4 and presented to the user at step 5.

The user has chances to look at the appointments that are visible to him/her, reset preferences and/or update the timing constraints of generated appointments. These changes are passed to the back-end system, at step 7, via JSP (at step 6). The new constraints, together with the 2-D resource matrix will be used as input, at step 8, to the workflow scheduler 74, to generate one or more new scheduled workflows, at step 9.

The scheduled workflow will again be transformed into JSP, at step 10 and presented to the user at step 11. The user can again have the option of setting up new preferences or updating generated appointments. This loop goes on until the customer is satisfied with the appointments. At the point (step 12), the scheduled tasks in the workflow will be passed to the Work Manager where the capacity of resource in each scheduled task is assigned to a specific enterprise resource (such as visit by a particular engineer).

FIG. 1B shows how in more detail schematically the processes performed by the workflow scheduler 74 shown in FIG. 1A according to an embodiment of the invention. In FIG. 1B, the workflow scheduler has generated an initially proposed workflow (which the end user 60 may have selected from a plurality of workflows in alternative embodiments of the invention) to which a user has added some additional constraints. The additional constraints are processed by the workflow scheduler which uses an interface application 78 (not shown in FIG. 1B) to determined how the requested constraints will impact the utilisation of resources required to implement the requested work. These resources are represented by a two-dimensional resource matrix in FIG. 1B in which each type of task required by a workflow requires a particular amount of time to be implemented (represented by a required number of timeslots). The workflow scheduler of the invention then optimises the use of the required resources (i.e., the task type and time-required) and returns one or more scheduled workflows to the user. The user is then able to either accept the proposed scheduled workflow or instead, provides further constraints, amends the previous constraints or if they so wish, starts the process from new.

FIG. 1C shows a workflow scheduling and appointment generation system according to one embodiment of the invention. In FIG. 1C, a user will set the initial constraints (10), for example, such as the start time and/or end time for the proposed workflow. A workflow is defined herein to comprise a plurality of tasks (equivalently referred to as jobs), for the purposes of completing a specific item of work. Tasks in a workflow may be organised in a plurality of sequentially dependent hierarchies, or example comprising one or more sequential or parallel streams of serially dependent tasks, and one or more tasks in one hierarchy or stream may have a dependency on one or more tasks in another stream. Once the user has set the initial constraints (step 10 in FIG. 1C) one or more provisional workflow is generated by a provisional workflow scheduler and appointment generator (step 12). One or more initial provisional workflow(s) is(are) communicated to the user, who is then able to set some additional local and/or global constraints on the individual and/or collective appointments proposed by the initial workflow (step 14). A revised workflow schedule is then generated (step 16). The revised workflow can again be fine-tuned or new preferences be added by the user, which constitutes a loop in the flow.

Finally, the revised workflow, which contains the local and/or global user selected constraints is communicated to A work manager which uses a 3-dimensional resource matrix to optimise the resource usage the selected workflow requires (18).

FIG. 2A shows more clearly how the invention is distinguished from a fine-tuning workflow manager system. In FIG. 2A the dashed lines represent steps from a fine-tuning workflow manager in which the user is not able to provide additional constraints to limit the output of the workflow manager, whereas the solid lines shown in FIG. 2B represents steps in a workflow system according to the invention.

In FIG. 2A, in the fine-tuning workflow system represented by the dashed lines, a user is able to generate a request and is able to sent some initial constraints (e.g., when should the workflow start and/or end by) (step 20). These are sent to a workflow scheduler which determines what tasks are required to fulfil the user's request, and which communicates information on the tasks required and the user's initial constraint(s) to a workflow manager (step 22). The workflow manager uses a 3-Dimensional resource matrix in which the axes represent the service provider, the service types and the time-slots available to optimise the utilisation of available resources for the requested workflow to generate a single proposed workflow which satisfies the global constraints set by the user and provides this to the workflow scheduler (step 24). The workflow scheduler then provides the user with details of the workflow (step 26), and the user is able to fine-tune the global constraints they initial set (step 28), the user's input provides additional constraints to fine-tune the workflow already generated by the workflow manager to enable the finally selected workflow to conform more closely with the user's requirements (step 30,32,34).

The system shown in FIG. 2A enables a user to revise the global constraints set for the generating the workflow, the user is not able to do more than fine-tune the workflow so that it conforms more closely with their global constraints. The initial workflow has, however, already checked resources are available when it was generated by the workflow manager, and it is only by providing more global constraints to the workflow manager that the workflow can be fine-tuned. The user cannot fine-tune to select a workflow which may not be optimal according to the workflow manager.

To enable a user to provide more specific constraints, workflow scheduler according to the invention includes a middleware application which functions as an interface between the workflow scheduler itself and the workflow manager of FIG. 2A (which is also capable of fine-tuning the workflows generated by the workflow scheduler according to the invention). Unlike the workflow manager shown in FIG. 2A, the work manager according to the invention optimises the utilisation of some of the system resources once the constraints imposed by the user have been determined.

Thus the workflow scheduler receives a request for work and some initial constraints (40), and generates a workflow. The term workflow is defined herein to comprise a series of tasks which are required to be completed to implement a particular request for work. The tasks may comprise one or more separate threads and may or may not be interdependent. Threads of tasks may be organised in dependency hierarchies such as is shown in FIG. 8 of the accompanying drawings (described in more detail later hereinbelow).

Once a workflow has been generated, interface application 78 responds to the proposed workflow generated by generating a plurality of potential schedules for the required workflows to determine how the workflow will utilise the required resources, for example, to determine the time-required for each task in the workflow. This is represented by a two-dimensional resource matrix. (Those skilled in the art will appreciate that in other embodiments of the invention the interface could allocate resources to the tasks forming a workflow in such a manner that the resources can be represented by a three-dimensional array or three-dimensional resource matrix etc). In other embodiments, the interface application could utilise a resource matrix to remove any requirement to access the workflow manager (as shown in FIG. 1A), providing the computational complexity of the scheduling a workflow using the three-dimensional resource matrix can be performed satisfactorily. The invention seeks to provide a workflow scheduling system in which additional constraints can be determined by the user prior to the work manager of the system determining one or more workflows which optimally utilise the systems available resources with the given constraints. In this way, although the final workflow may not be as optimal as would be the case if the user was not able to set additional constraints, the user has more control over the range and duration of the appointments generated by the workflow scheduler.

In FIG. 2B, a user first generates a request and selects one or more initial constraints via a user interface (step 40). The workflow scheduler then generates an initial proposed workflow to fulfil the request which indicates what tasks or jobs are required and a proposed sequence and interdependency (step 42) and provides the proposed workflow and the global constraints to the interface application. The interface application generates a plurality of proposed schedules for the workflow (44) which satisfy the initial global constraints (which are timing constraints, for example, an earliest start time and/or date and/or a completion time and/or date) using a two-dimensional resource matrix, described in more detail later herein below. The proposed schedules for the workflow are communicated to the end user by the workflow scheduling application which prompts the user to provide one or more additional global and/or initial constraints (step 46) for one of the proposed workflow schedules. The user is advised of all or a fixed number of the potential workflows the intermediate application has generated using the 2-D resource matrix. The fixed number can be set up as a parameter for the system.

The user adds additional constraints (step 48) which may be global constraints such as the start and/or end time for the entire series of appointments necessary to implement the workflow proposed and/or local constraints on one or more individual appointments, such as the time-duration of each appointment, which are communicated via the preference scheduling application (step 48) to the middleware application (step 50). Other examples of global constraints include the time-span being only on one day (i.e., both start and end times on the same day etc.). The preference workflow scheduler provides these additional constraints to the middleware application (interface) (step 50) which then revises the proposed schedules for the workflows to ensure appropriate utilisation of certain resources. The data relating to the resources is held in one or more data stores, for example the back-end resources database shown in FIG. 2B may comprise both the database 70 and the preference database 76 shown in FIG. 3 and described later hereinbelow). The utilisation of these resources is represented in a two-dimensional array or matrix by the middleware application, and used to generate one or more workflows conforming with the additional constraints the user has generated. The two-dimensional resource data store in this embodiment of the invention represents only the time-slots and service types, and does not take into account specific service provider availability. The workflow scheduler middleware application will then proposes one or more revised workflows which ideally optimally utilise the resources the middleware application has access to via a back-end resource data store (step 52), or at least conform with one or more criteria for accepting the level of resource utilisation a proposed workflow must conform with as well as conforming to the additional and initial constraints set by the user. This enables the user to exert more control over the scheduling process than if they are only able to fine-tune the scheduling of a workflow generated by a workflow manager such as is shown in FIG. 2A.

In this embodiment, the workflow scheduler selects one or more of the revised workflows and presents it to the user. The user is able to accept the workflow (step 56) or repeat the process of specifying initial constraints (i.e., starting from scratch) or providing additional constraints. In other embodiments, one or more of the revised workflows is retained by the workflow scheduler so that if the user seeks to revise a revised workflow even further by adding or revising the additional constraints, the computational complexity of the task can be greatly reduced. If the user accepts the proposed workflow, the workflow can be optionally passed to a work manager (step 57), for example, to a fine-tuning workflow manager such as is shown in FIG. 2A, which seeks to optimise the utilisation of resources using a three-dimensional resource array of service provider for each task, service (i.e., task), and time-slots required. An example of such a workflow manager is described in UK patent application GB-A-0427133, entitled “Workflow Scheduler” which was filed on 10th Dec. 2004.

In embodiments of the invention in which a work manager is provided, the work manager seeks to further optimise the resources is able to ensure that all the resources of the workflow system are utilised as optimally as possible, given the additional constraints the user has placed on the system. The work manager then generates a proposed workflow and communicates this to the enterprise backend resource, such as field engineers.

Thus the invention is distinguished from a simple fine-tuning workflow scheduling system by providing a middleware application enables a workflow to be proposed to the workflow scheduler which is pre-configured to ensure the user's initial and additional (global and/or local) constraints are satisfied. The workflow scheduling system is arranged to provide a user interface in a front-end portal which enables the user to have the opportunity to incorporate one or more additional constraints after they have set initial constraints for any work to be done associated with their requests for service.

The architecture of the back-end of the preference-based workflow scheduling system shown in FIG. 1A will now be described with reference to FIG. 3. The left-hand side of FIG. 3 schematically shows the front-end 64 of the system. User 62 interacts with the workflow scheduling system 60 via the customer front end 64 which comprises a user interface, for example, a web-based user interface comprising Java Servlet Pages (JSP) which mediate between the user 62 and back-end system 66, which deals with the customer request.

In one embodiment of the invention, the front-end 64 provides an appropriate interface which allows a customer to provide appropriate verification details if access to the system is to be restricted or if security is required, for example, the user interface may enable a customer to log into the system by providing user name and password. Back-end 66 provides means to prompt a user to select a preference 68, for example, an application enabling the user to select a preference, i.e., one or more local and/or global constraints, which is supported on a server. The server application is arranged to have access to data held in a data store 70 of possible constraints. The back-end further comprises means 72 to receive the user's selected preferences (i.e., the constraints to be imposed on the workflow). The one or more constraints selected by the user are provided to a preference based workflow scheduler 74 which incorporates an appropriate middleware application 78 which is arranged to have access to data held in a preference implementation data-base (which provides implementation methods for particular preferences).

In this way, the workflow scheduler 74 incorporates the local and/or global constraints and uses methods from a preference implementation data store 76, to generate a plurality of workflows. In the above embodiment, a user login and service selection input steps have been omitted but can be implemented in alliterative embodiments of the invention.

The “Preference Base” data store 70 stores a list of preferences that can be used to guide the generation of provisioned workflow. The available preferences are presented to a user, for example a customer, through the interface of service portal 64. The user selects one or more of the preferences via the user interface provided by the service portal 64. The selected preferences comprise constraints which are then fed into “preference-based workflow schedule generation” module to guide the generation of provisioned workflows. At this stage, code from preference implementation data base 76 will be called upon to help fulfil this function. The provision of two separate data-bases, i.e., by separating preference base and preference implementation base from the rest of the system, the workflow system is made configurable (for example, by the end-user or the system designer, or an operator). For instance, it is possible to add new preferences (i.e., to enable more local and/or global constraints to be included) which can be implemented and deployed without the need to change or re-compile the existing system.

FIG. 4 shows steps in the system for generating a workflow according to one embodiment of the invention. In this embodiment, a user first logs into the system (step 80) and requests one or more services (step 82), for example, by selecting one service from a list of services. Optionally, the user may be asked to set one or more initial global constraints. A provisional workflow that maps to the selected service 84 is then generated by the back-end 66 (step 84), conforming to the global constraints if provided.

Once a provisional workflow has been generated (step 86), the user will be prompted to enter one or more preferences which can be used by the back-end 66 to generate a list of provisioned workflows, for example, a customer can tick or activate radio-buttons on a web-page to indicate a set of one or more preferences that can be used to guide the generation of a list of provisioned workflows. These preferences provide further constraints which the preference based workflow scheduler interface according to the invention uses to generate a further list of provisioned workflows. The provisioned workflows are communicated to a work manager which then generates a workflow which will optimally utilise the resources required by the selected service. The workflow in the embodiment shown is generated by a workflow scheduling fine-tuner. The user is able to fine-tune the workflow, and once accepted, the system proceeds to execute and monitor the workflow.

Thus, after selecting one from these provisioned workflows, the provisioned workflow can be fine-tuned until satisfactory to the user, and finally the confirmed provisioned workflow is communicated to a workflow execution engine. The engine processes the received information to enable the workflow to be executed and the progress of the workflow monitored.

Two embodiments of the invention will now be described in more detail which provide algorithms for implementing the user preferences “Least Time Span” and “Fewest number of Appointments”.

GB-A-0427133 describes a workflow scheduling algorithm in which the inputs to the algorithm include overall timing constraint, a workflow and a resource matrix. The output of the algorithm is a provisioned workflow where each action in the workflow is assigned with a value that can be found in the resource matrix. The assigned value in each action in the workflow satisfies both the overall timing constraint and the temporal dependencies between tasks.

One embodiment of the invention provides a workflow scheduling system comprising an algorithm for computing a scheduled workflow with a global constraint comprising the workflow has the least time span.

Given an overall timing constraint, a resource matrix and a workflow, may possible provisioned workflows can be proposed, each having a potentially different time span. This is due to the various distribution booked resources can have that block the allocation of resource during the workflow scheduling process.

In this embodiment of the invention, the time-span is constrained, ideally to the least possible, or to below a maximum time-span permitted. The embodiment below describes the invention in terms of the least-time-span forming the constraint, but those skilled in the art will find apparent how to modify the given algorithm to ensure the permitted time-span is instead below a maximum permitted value. Let InitStartTime be the start time in the overall timing constraint, InitFinishTime be the finish time in the overall timing constraint. Let finishTime=Schedule(startTime, workflow, resourceMatrix) be the scheduling function that takes the startTime, workflow and resourceMatrix as inputs and generate the finishTime as output. Let timeSpan be the time span of the scheduled workflow, leastStartTime, leastFinishTime and leastTimeSpan be the start time, finish time and time span for the scheduled workflow with least time span respectively. Let TimeUnit be the time unit for workflow scheduling, say 1 hour. The algorithm for computing the scheduled workflow with least timing span according to this embodiment of the invention is given below:

Computing Scheduled Workflow with Least Time Span Algorithm

```
BEGIN
StartTime [symbol] initStartTime;
FinishTime [symbol] Schedule(startTime, workflow, resourceMatrix);
TimeSpan [symbol] finishTime − startTime;
LeastTimeSpan [symbol] TimeSpan;
LeastStartTime [symbol] startTime;
LeastEndTime [symbol] endTime;
While(finishTime < InitFinishTime) DO
    StartTime [symbol] StartTime + TimeUnit;
    FinishTime [symbol] Schedule(StartTime, workflow, resourceMatrix);
    TimeSpan [symbol] finishTime − startTime;
    If (timeSpan < leastTimeSpan) THEN
        LeastTimeSpan [symbol] timeSpan;
        LeastStartTime [symbol] startTime;
        LeastEndTime [symbol] endTime;
    ENDIF
ENDWHILE
END
```

The algorithm will iteratively compute the scheduled workflow within the time span of initial timing constraint. It moves from initial start time towards initial finish time, with a moving step timeUnit. The scheduled workflow with the shortest time span will be selected as the target one.

Another embodiment of the invention comprises a workflow scheduling system comprising an algorithm for computing N scheduled workflows with the global constraint that the entire workflow has a time-span below a maximum permitted value, for example, that it is the least time span possible.

Another embodiment extends the above-mentioned algorithm so that it can generate N scheduled workflows with least time span (similarly to the above case, alternative embodiments are possible which modify the algorithm so that instead it constrains the time-span below a maximum value; a modification which is apparent to those skilled in the art on reading this embodiment.) This gives the end-user, for example, a customer, an opportunity to choose one from the scheduled workflows that can best suit for their need(s). Let N be the number of scheduled. NLeastTimeSpanWorkflow be N scheduled workflow with least time span. The notations given in the previous section are reused in this section.

Algorithm for Computing N Scheduled Workflows with Least Time Span

```
BEGIN
    NleastTimeSpanWorkflow [symbol] null;
    StartTime [symbol] initStartTime;
    FinishTime [symbol] Schedule(startTime, workflow, resourceMatrix);
    TimeSpan [symbol] finishTime − startTime;
    LeastTimeSpan [symbol] TimeSpan;
    LeastStartTime [symbol] startTime;
    LeastEndTime [symbol] endTime;
    NleastTimeSpanWorkflow [symbol] (LeastTimeSpan, LeastStartTime,
    LeastEndTime)
    While(finishTime < InitFinishTime) DO
        StartTime [symbol] StartTime + TimeUnit;
        FinishTime [symbol] Schedule(StartTime, workflow, resourceMatrix);
        TimeSpan [symbol] finishTime − startTime
        i [symbol] N;
        WHILE (timeSpan < timeSpan(NleastTimeSpanWorkflow[i]) )
        DO
            i [symbol] i −1;
        ENDWHILE
        Insert(timeSpan, startTime, endTime) into
        NleastTimeSpanWorkflow at i+1;
    ENDWHILE
END
```

The algorithm operates by opening a buffer that can hold N scheduled workflows. Each time a new scheduled workflow is generated, it will be compared against the scheduled workflow in the buffer to see whether its time span is smaller than those already in the buffer. If it is, the scheduled workflow will be inserted into the buffer at appropriate position. It is noted that the scheduled workflow in the buffer is already sorted. If the insertion of a scheduled workflow leads to overflow the buffer, the overflow one will be disregarded. At the end of the algorithm, the buffer contains N or less than N scheduled workflow that has least time span.

Another embodiment of the invention provides a workflow scheduling system comprising a algorithm enabling a workflow to be scheduled with a global and/or local constraint limiting the appointments generated to a predetermined maximum number of appointments and/or the fewest number of appointments. In this embodiment, the workflow scheduling system also includes an algorithm for generating appointments from a scheduled workflow.

In one embodiment, the scheduled workflow represents a view from the enterprise side. When the scheduled workflow is presented to the end-user, for example, a customer, the scheduled workflow is mapped into appointments that the end-user can individually and/or collectively interact with. In this embodiment, given a scheduled workflow, the job of generating appointments is to merge the scheduled tasks in the workflow into single appointments.

The merging of the tasks is guided by selected policy, for instance, the morning session policy directs that all the tasks that occur in the same morning session can be merged into a single appointment. The following algorithm describes how appointments can be generated from scheduled workflow directed by morning session policy. Let Task be a task in the workflow, N be the total number of tasks in the workflow, Tasks be the total set of tasks in the workflow. Let startTime(task), endTime(task) be the start time and end time for the scheduled task, respectively.

Algorithm for Generating Appointments from Scheduled Workflow Guided by Morning Session Policy.

```
BEGIN
FOR i [symbol] 1 TO N DO
Task [symbol] Tasks[i];
    FOR j [symbol] 1 TO SIZEOF(APPOINTMENTS) DO
        Appointment [symbol] APPOINTMENTS[j];
        IF InTheSameMorningSession(Task, Appointment) THEN
            Appointment [symbol] Task;
            Break;
        ENDIF
    ENDFOR
    IF InTheMorningSession(Task) THEN
        Appointment [symbol] new Appointment(Task);
        APPOINTMENTS [symbol] Appointment;
    ENDIF
ENDFOR
END
```

The algorithm will operate by iteratively look at each task in the workflow and try to merge the tasks that are in the same morning session into single appointment. If it find a task that is not in any existing appointment, it will generate a new appointment. If it find a task that has already falls into one of the existing appointment, it will merge this task into this appointment. At the end of this algorithm, APPOINTMENTS will contain all the appointments that occur in separate morning sessions.

Similarly, another embodiment of the invention provides a workflow scheduling system in which an algorithm for generating afternoon session appointments is provided, such as is shown in the example below

Algorithm for Generating Appointments from Scheduled Workflow Guided by Afternoon Session Policy.

```
BEGIN
FOR i [symbol] 1 TO N DO
Task [symbol] Tasks[i];
    FOR j [symbol] 1 TO SIZEOF(APPOINTMENTS) DO
        Appointment [symbol] APPOINTMENTS[j];
        IF InTheSameAfternoonSession(Task, Appointment) THEN
            Appointment [symbol] Task;
            Break;
        ENDIF
    ENDFOR
    IF InTheAfternoonSession(Task) THEN
Appointment [symbol] new Appointment(Task);
        APPOINTMENTS [symbol] Appointment;
    ENDIF
ENDFOR
END
```

At the end of the above algorithm APPOINTMENTS will contain all the appointments that occur in the afternoon session.

In the embodiment in which the workflow scheduling system comprises an Algorithm for selecting scheduled workflow with fewest appointments, Let TASKS be all the task contained in a workflow, GenerateMorningSessionAppointments(tasks) be the function of generating appointments for tasks using morning session policy, GenerateAfternoonSessionAppointments(tasks) be the function of generating appointments for tasks using the afternoon session policy. The algorithm for selecting scheduled workflow with fewest appointments is described as follows.

Algorithm for Electing Scheduled Workflow with Fewest Appointments:

| BEGIN | |
|---|---|
| FewestNumber [symbol] VERYLARGENUMBER | |
| FewestNumberAppointmentWorkflow [symbol] null | |
| DO | |
| StartTime [symbol] initStartTime; | |
| (ScheduledWorkflow, FinishTime) [symbol] Schedule(startTime, | |
| workflow, resourceMatrix); | |
| StartTime StartTime + TimeUnit; | |
| NumberOfMorningAppointments | [symbol] |
| generateMorningSessionAppointments(scheduledWorkflow); | |
| NumberOfAfternoonAppointments | [symbol] |

```
generateAfternoonSessionAppointments(scheduledWorkflow);
        IF fewestNumberAppointment >
numberOfMorningAppointments + numberOfAfternoonAppointments
THEN
            FewestNumberAppointmentWorkflow [symbol] workflow;
        ENDIF
    UNTIL finishTime >= InitFinishTime
END
```

The algorithm will iteratively look at each possible scheduled workflow within the time span given by the overall timing constraint. At each step, it calculates the total number of appointments in the morning session and in the afternoon session, and records the scheduled workflow that has the fewest number of appointments. At the end of algorithm, fewestNumberAppointmentWorkflow will contain the scheduled workflow that has the fewest number appointments.

The workflow language is composed of a variety of program constructs for describing variable, expressions, control flows, actions, assignments and exception handling. For scheduling purposes, however, only the control flows and actions are required. The Backus Naur Form (BNF) meta-symbol notation will be used to formally describe the workflow language syntax, in which the meta-symbol notation ::= means “is defined as”, | means “or”, and < > angle brackets surround category names. The angle brackets distinguish syntax rules names (also called non-terminal symbols) from terminal symbols which are written exactly as they are to be represented. A BNF rule defining a nonterminal has the form: nonterminal ::= sequence_of_alternatives consisting of strings of terminals or nonterminals separated by the meta-symbol |.

The BNF of the relevant control flow and action program constructs are therefore:

| | |
|---|---|
| Workflow ::= | Statement |
| Statement ::= | SequentStatement |
| | \| ParallelStatement |
| | \| SwitchStatement |
| | \| Action |
| SequentStatement ::= | Statement |
| | \| Statement SequentStatement |
| ParallelStatement | ::= Statement |
| | \| Statement ParallelStatement |
| SwitchStatement | ::= SwitchCases |
| SwitchCases ::= | SwitchCase |
| | \| SwitchCase SwitchCases |
| SwitchCase ::= | Condition Statement |
| Action ::= | ServiceType, (note that ServiceType ::= String) |

The Condition BNF is not essential to the workflow scheduling algorithm according to the invention. It is equivalent to a logical expression in that the evaluation of Condition can only be done at run time rather than at scheduling time, because the value of the variable is only available at run time. As a result, at the scheduling stage, it is assumed that all paths in the work process are to be executed and the workflow is scheduled with this assumption. For instance, if a program construct has multiple branches, it is assumed that the duration of this construct is the longest among all these branches. It is in this sense that the evaluation of condition is not important at scheduling stage.

Let constrainedStart be the initial schedule constraint after which the user wishes the job to start; constrainedEnd be the initial schedule constraint before which the user wishes the job to finish; scheduledEnd be the finishing time of the scheduled workflow. Let Sch( ) be function of scheduling. One embodiment of a scheduling algorithm is as set out below:

Algorithm: Workflow Scheduling.

Input: workflow, constrainedStart, constraintEnd.

Output: scheduledWorkflow.

Step 1. Compute the finishing time of the workflow schedule. This can be achieved by calling Sch(workflow, constrainedStart, scheduledEnd), where workflow and constrainedStart are the inputs and scheduledEnd is the output. The following bullet points describe the semantics of these program constructs and how they work together to fulfil the function.

```
Sch(workflow, constrainedStart, scheduledEnd) -> Sch(statement, constrainedStart,
scheduledEnd).
Sch(statement, constrainedStart, scheduledEnd) ->
    switch(statement){
        case “sequentStatement”: Sch(sequentStatement, constrainedStart,
scheduledEnd); break;
        case “parallelStatement”: Sch(parallelStatement, constrainedStart,
scheduledEnd); break;
        case “switchStatement”: Sch(switchStatement, constrainedStart,
scheduledEnd); break;
        case “action”: Sch(action, constrainedStart, scheduledEnd); break;
    }
Sch(sequentStatement, constrainedStart, scheduledEnd) -> Sch(statement,
constrainedStart, scheduledEnd1), Sch(sequentStatement, scheduledEnd1,
scheduledEnd).
Sch(parallelStatement, constrainedStart, scheduledEnd) -> Sch(statement,
constrainedStart, scheduledEnd1), Sch(parallelStatement, constrainedStart,
scheduledEnd2), scheduledEnd=Latest(scheduledEnd1, scheduledEnd2).
Sch(switchStatement, constrainedStart, scheduledEnd) -> Sch(switchCases,
constrainedStart, scheduledEnd).
Sch(switchCases, constrainedStart, scheduledEnd) -> Sch(switchCase, constrainedStart,
scheduledEnd1), Sch(switchCases, constrainedStart, scheduledEnd2),
scheduledEnd=Latest(scheduledEnd1, scheduledEnd2).
Sch(switchCase, constrainedStart, scheduledEnd) -> Sch(statement, constrainedStart,
scheduledEnd).
Sch(action, constrainedStart, scheduledEnd) ->To be refined.
```

Step 2: Check whether the finishing time meets the deadline.

```
if (Before(scheduledEnd, constrainedEnd)){
    Schedule is successful AND “scheduled workflow” = (workflow +
scheduledResources).
} else {
    Schedule fails.
}
```

The above algorithm operates by first computing the finishing time of the scheduled workflow and comparing it with the constrained finishing time of user requirement; if the former finishes before the latter than the scheduling task is successful; otherwise it fails. In Step 1 above, the computation of scheduledEnd and the scheduling of actions are carried out in a recursive way, by following the semantics definition of each program construct. For example, considering the first bullet point above, its semantics can be interpreted as: in order to schedule “workflow”, given the inputs of “workflow” and “constrainedStart”, we need to first schedule “statement”, the inputs of which are “statement” and “constrainedStart”. The “statement” is the one used in the BNF of “workflow”, and the “constrainedStart” is the same as the “constrainedStart” in “workflow”. After scheduling, “scheduledEnd” will be returned as the output, which can be further returned as the “scheduledEnd” of workflow scheduling.

The semantics of the scheduling action will now be described in more detail.

Let M be a resource matrix, M={STi, 1<=i<=nst}, where STi is a service type and nst is the total number of service types. Let SLS(STk)={SLm, 1<=m<=nsl(STk)} be a set of available time slots for service type STk, where SLm is an available time slot and nsl(STk) is the total number of service type STk.

Let C={CAP(SLm), 1<=m<=nsl(STk)} be the capacity of each time slot SLm, where nsl is the total number of time slots for Service Type k.

Let TW(STk) be the time window for service type STk; the time window is the operational time length for STk to complete the action.

Let A be an action, CS be constrained starting time of A, SE be scheduled end time for A, CONFIRMED be a Boolean variable indicating whether A has got a schedule that is confirmed, CSS and CSE be the start time and finish time of the confirmed schedule, respectively.

The problem of scheduling A is to find an available time slot SLm, among the resource matrix, where the timing constraint of A can be satisfied. This can be described in pseudocode as:

```
Sch(action, CS, SE) ->
if(CONFIRMED){
    if(before(CSS, CS)){
        ScheduleFails.
    }
SE=CSS.
} else {
    ST=ServiceType(action),
    {SL1...SLm} = GetTimeSlots(CS, TW(ST))
    FOR i= 1 TO m DO
        IF CAP(SLi) <= 0 THEN
            ScheduleFails.
        ENDIF
    ENDFOR
    SE=CS+TW(STk).
}
```

The above algorithm operates by finding a list of timing slots that are needed to fulfil a particular service type, given a preferred start time (in this case, CS). It will then look up the resource matrix to see the capacity of each service type; if there is empty capacity of particular service type at specific time slot, the schedule will fail. If all the time slots can be satisfied by the capacity of the resource matrix, the schedule is successful and CS plus the time window for executing the service type will be returned as the finish time of the scheduling of this action.

Thus in one embodiment, the workflow scheduling system according to the invention allows an end-user, for example a customer, to request work and to make appointment reservations on-line for the work to be implemented using a front-end interface arranged to remotely interact with a back-end workflow scheduler. This embodiment of the invention is particularly suited for when the end-user is required due to the nature of work requested make a series of appointments. The invention facilitates the end-user setting his/her preferences on the appointments that can be generated from the workflow schedule, and reduces the amount of time the user must spend “fine-tuning” a workflow.

The user gets the benefits of choosing the optimal scheduled workflow from those can be possible to suit for his/her own need, an the user's requirements take priority in some embodiments of the invention over the utilisation of at least one of the resources required to implement the work the user requests. These include finding a scheduled workflow with shortest time span or having as few appointments as possible. The workflow scheduler according to the invention can be used by enterprises to potentially enhance customer satisfaction without impacting the enterprise's operational efficiency and resource utilisation too adversely.

FIG. 5 shows a workflow which may be generated according to the invention. FIG. 5 shows schematically a workflow in which two threads of tasks having interdependency are required to implement a service request for call management routing. The workflow thread A requires the task of firstly querying the network operations centre (NOC) for the type of access required to implement the requested service. Thread B independently requires the Service Management Centre (SMC) to be queried to determine the specifications for the requested service. Next, Thread A request the service order to be despatched, after which the private branch exchange (PBX) can be configured, after which the product is installed. This is followed by the task of configuring the private branch exchange, which is in this example performed automatically. The call management service is then installed, and finally the call routing service is installed.

Thread B comprises after the task of querying the SMC for specifications, the task of obtaining the public service telephone network (PSTN) telephone number from the NOC, which is followed by the task of provisioning the business continuity management mini office, which is followed by the task of sending a configuration script to the NOC database, which then is followed by the above-mentioned task of configuring the private branch exchange, which is in this example performed automatically, followed by the task of installing the call management service, and finally by the task of installing the call routing service, which completes the customer's request. As this example of a complex workflow shows, although two separate threads of work-flow tasks exist (threads A and B), the individual tasks are related. Also, thread C is dependent on both threads A and B having been completed.

For example, if a user of the customer portal 64 may want to ensure that not only are the appointments requiring site visits all completed before noon, but that the entire service is installed by a specific time and date. The invention provides an front-end interface and supporting back-end workflow scheduler which enables such a customer request to be controlled by the customer, and then optimised by the workflow scheduler (and possibly optimised further by a work manager). The workflow scheduler of the invention is able to schedule the individual appointments (over which the user has no visibility) by dynamically generating the local constraint (such as starting time) on each action, calculating the finishing time of each action (based on the staring time and task duration) and propagating these constraints through dependency links in the workflow. For instance, at the beginning stage, an initial global timing constraint on when the whole workflow can be started has been set by the user (or in other embodiments, this may be automatically set by the system, and/or the system designer, and/or system operator and/or be dependent on then work requested).

This constraint is used as the starting time for the first-level tasks in the workflow, such as “Query NOC for Access Type” and “Query SMC for Specifications”. Based on the duration of the above-mentioned two tasks, the finishing time can be calculated of each action that is used as constraint for calculating the starting time of each action in the second-level, such as “Dispatch Service Order” and “Get PSTN Numbers from NOC”. Take “Dispatch Service Order” for example, the starting time of this action is calculated as the latest finishing time of “Query NOC for Access Type” and “Query SMC for Specifications”. Once a starting time is obtained, the finishing time can be calculated, and propagated across the workflow. At the end of this process, all the actions will have been allocated resource capacity or if one of these actions could not be allocated resource capacity, the scheduling process fails and aborts.

Those skilled in the art will find it apparent that the embodiments of the invention described hereinabove can be combined in any appropriate manner to provide a workflow scheduling system having a plurality of different options, for example, to generate a workflow that has the shortest duration, or that finishes quickest, or that has as few appointments as possible. Those skilled in the art will be aware that the term “Preference-based Workflow Scheduler” is used equivalently to the term “workflow scheduler” in the context of a workflow scheduler according to the invention in which constraints are provided by the end-user. A workflow scheduler according to the invention receives input comprising an overall, i.e., global constraint, and any task constraints (additional constraints), and outputs a scheduled workflow by firstly dynamically selecting the best resource for each task, then dynamically generating one or more new constraints which are merged with any existing constraints, and finally by dynamically propagating the constraint(s) across the workflow.

The scheduling is based on resource capacity, i.e., on the resources themselves rather than individual (e.g. engineer) bookings to provide a “can the enterprise” (i.e., the collection of individuals, i.e., engineers) respond, rather than “which individual” will do the job. This reduces the time for on-line reservation and enables the “work will do the job” process to be taken care of separately by a work manager or automated attendance system or the like.

By separating “Work Manager” and “Workflow Manager”, it is possible to respond to customer requests more promptly, whilst optimising enterprise resource(s) at the backend remain possible.

The Workflow Manager has the function of workflow scheduling, i.e., allocating resource capacity to each task in the workflow while respecting the constraints (such as temporal dependency among tasks) imposed on it. In one embodiment, the resource capacity can be as simple as whether the job can be done. In another embodiment, it can be a concrete allocated BT engineer.

Work Manager looks more at how to allocate concrete enterprise resource (such as a particular BT engineer visit) to each task. It has scope of optimising the enterprise resource, for instance, making BT engineer happy by letting them travel as short distance as possible. The input to Work Manager is the output of Workflow Manager. The temporal dependency among tasks is not important here, since each task has been allocated resource capacity (with timing slots).

1. A workflow scheduling system arranged to provide a workflow to a user who has requested work to be implemented, the system comprising:
means to generate a workflow comprising a set of actions and a logical dependency between the actions;
means to allocate a resource capacity to each action;
means to assign of one or more of said resources forming the resource capacity to a task comprising one or more of said actions,
wherein the system is arranged to enable a user to add one or more constraints dynamically to the workflow scheduling system without the need for the workflow scheduler to be recompiled to apply said one or more constraints to the resources allocated to said one or more tasks.

2. A system as claimed in claim 1, wherein said means to allocate a resource capacity to each action allocates resource capacity based on the type of task an action forms and the time-slots available to implement that type of task, wherein each time-slot is representative of the total resource capable of performing the task.

3. A system as claimed in claim 2, wherein the total resource each time-slot is representative of comprises the total number of individuals capable of performing a type of task.

4. A system as claimed in claim 1, wherein said means to allocate a resource capacity to each action comprises means to allocate resource capacity in dependence on the availability of each resource required.

5. A system as claimed in claim 1, wherein a resource comprises one of the following: type of task, an individual, and each individual's available time-slots.

6. A system as claimed in claim 1, further comprising:
means to allocate one or more appointments for the required resources to implement all tasks required to fulfil the request for work, wherein the means to allocate one or more appointments is arranged to maximise the number of tasks allocated to each appointment.

7. A system as claimed in claim 6, wherein said means to allocate comprises one or more appointments is arranged to merge a plurality of logically related tasks into single appointments, which can then be scheduled by the workflow system.

8. A system as claimed in claim 7, wherein the user is capable of selecting one or more of a plurality of appointments offered by the system.

9. A system as claimed in claim 8, wherein if the user selects an inconsistent appointment for a particular task or set of tasks in the workflow, an indication of the inconsistency is provided to the user.

10. A method of scheduling a workflow generated in response to a user generating a request for work, the workflow comprising a plurality of tasks each of which must be implemented to fulfil the request for work, the method comprising:
receiving a user initiated request for work;
receiving input from the user comprising one or more initial constraints on a schedule for fulfilling the request for work;
generating a workflow to fulfil said request for work;
processing said one or more initial constraints inputted by the user;
generating one or more proposed schedules for the workflow, the schedules complying with said one or more global constraints;
communicating information relating to said one or more proposed schedules to the user;
receiving one or more additional constraints from the user for a schedule to implement the proposed workflow;
processing said additional constraints inputted by the user to generate one or more revised schedules for the proposed workflow which comply with said one or more additional constraints;
selecting one of said revised proposed workflows according to a set of one or more optimisation rules; and
communicating said selected revised proposed workflow to the user.

11. A method as claimed in claim 10, wherein the user is able to add one or more additional constraints dynamically without the need for the workflow scheduler to be recompiled.

12. A method as claimed in claim 10, wherein the steps in the method are arranged to enable a user to iterate the additional constraint selection step and subsequent steps to further constrain the revised proposed workflows.

13. A method as claimed in claim 10, wherein the steps in the method are arranged to enable a user to fine-tune the selected revised proposed workflows.

14. A method as claimed in claim 10, wherein an initial constraint comprises a global constraint.

15. A method as claimed in claim 10, wherein said additional constraint comprises a global constraint.

16. A method as claimed in claim 10, wherein said additional constraint comprises a local constraint.

17. A method as claimed in claim 14, wherein said global constraint comprises a start time and/or an end time and/or a duration for the entire workflow.

18. A method as claimed in claim 16, wherein said local constraint comprises a start time and/or an end time and/or a duration for one or more tasks forming a subset of the tasks forming the entire workflow.

19. A method as claimed in any one of claims 10 to 18 claim 10, wherein the additional constraint constrains the number of appointments required to implement the work to a predetermined number.

20. A method as claimed in claim 19, wherein the additional constraint constrains the number of appointments required to implement the work to the least number required.

21. A method as claimed in claim 10, wherein said optimisation rules seek to optimise the utilisation of the collective capacity a resource requires to implement the work requested.

22. A method as claimed in claim 21, further comprising the step of seeking to optimise the utilisation of each individual resource required prior to said step of communicating the workflow to the end-user.

23. A method as claimed in claim 22, wherein said further step of seeking to optimise the utilisation of each individual resource comprises communicating the revised workflow to a work manager arranged to optimise the utilisation of each individual resource, and wherein said work manager performs said step of further optimising the workflow, and said work manager communicates said further optimised workflow to the workflow scheduling system for communication to the end-user.

24. A workflow scheduling system arranged to schedule a workflow generated in response to a user generating a request for work, the workflow comprising a plurality of tasks each of which must be implemented to fulfil the request for work, the apparatus comprising:
means to receive a user initiated request for work;
means to receive input from the user comprising one or more initial constraints on a schedule for fulfilling the request for work;
means to generate a workflow to fulfil said request for work;
means to process said one or more initial constraints inputted by the user;
means to generate one or more proposed schedules for the workflow, the schedules complying with said one or more global constraints;
means to communicate information relating to said one or more proposed schedules to the user;
means to receive one or more additional constraints from the user for a schedule to implement the proposed workflow;
means to process said additional constraints inputted by the user to generate one or more revised schedules for the proposed workflow which comply with said one or more additional constraints;
means to select one of said revised proposed workflows according to a set of one or more optimisation rules; and
means to communicate said selected revised proposed workflow to the user.

25. A user interface arranged to enable a user to provide input to the system as claimed in claim 24, wherein the user interface comprises:
means for a user to initiate a request for work to be scheduled by the system;
means to provide input from the user to the system comprising one or more initial constraints on the schedule the system is to generate for fulfilling the request for work;
means to provide one or more additional constraints from the user to the system for the schedule to implement the proposed workflow;
means to receive information indicated the workflow finally proposed by the system to fulfil the requested work.

26. A scheduling system for use in a workflow scheduling system according to claim 24, the scheduler comprising:
means to generate one or more proposed schedules for a workflow, the schedules complying with said one or more global constraints;
means to communicate information relating to said one or more proposed schedules to the system for communication to the user;
means to receive one or more additional constraints from the user for a schedule to implement the proposed workflow;
means to process said additional constraints inputted by the user to generate one or more revised schedules for the proposed workflow which comply with said one or more additional constraints;
means to select one of said revised proposed workflows according to a set of one or more optimisation rules; and
means to communicate said selected revised proposed workflow to the user via said system.

27. An appointments generator arranged for use in the system as claimed in claim 24, wherein the appointments generator is provided as part of an appointment reservation system implemented in a distributed computing environment arranged to permit multiple access to the system, and in which each user is allocated a single session, each session storing information on the user's appointment preferences.

28. A computer program comprising instructions for causing one or more processors to perform the method according to claim 10 when the instructions are executed by the processor or processors.

29. A suite of one or more computer programs providing a workflow scheduling system according to claim 1.
